(19) United States
(12) Patent Application Publication
(10) Pub. No.: US 2005/0092350 A1
(43) Pub. Date: May 5, 2005

(54) Scrubbing brush with ligand attachments

(76) Inventor: Mark Buehler, Portland, OR (US)

Correspondence Address: Timothy N. Trop;TROP, PRUNER & HU, P.C., STE. 100, 8554 KATY FWY, HOUSTON, TX, 77024-1841, US

(21) Appl. No.: 10/698,323

(22) Filed: Oct. 31, 2003

(51) Int. Cl. B08B 7/00

(52) U.S. Cl. 134/6; 134/2; 15/77; 15/230; 15/244.4

(57) ABSTRACT

A semiconductor wafer cleaning brush may have ligands attached along the length of its polymer chain. These ligands may provide moieties with specific functional features such as providing a hydrophilic characteristic, a hydrophobic characteristic, a reducing agent, or an oxidizing agent, to mention a few examples. In addition, the attaching ligand may provide a mechanical cleaning structure that is effective in reaching into small areas on the wafer to be cleaned. The ligand may be attached to the length of the brush polymer using a hydrolysis reaction in one embodiment.

### BACKGROUND

This invention relates generally to brushes that may be utilized for scrubbing and/or cleaning semiconductor wafers.

During semiconductor integrated circuit fabrication, a wafer may be subjected to a variety of different processes that may necessitate subsequent cleaning. For example, after chemical mechanical polishing, it is common to clean the wafers. In this regard, the wafers may be placed between counter-rotating brushes which scrub the wafers clean. At the same time, chemical cleaning solutions may be sprayed at the interface between the wafer and the brushes.

If the wafers are not adequately cleaned, defects may occur. Each wafer may include a large number of die which ultimately become integrated circuits.

Thus, it is desirable to reduce the defects in semiconductor wafers by providing better cleaning.

### BRIEF DESCRIPTION OF THE DRAWINGS

FIG. 1 is a schematic depiction of one embodiment of the present invention; and

FIG. 2 is a schematic depiction of a chemical process in accordance with one embodiment of the present invention.

### DETAILED DESCRIPTION

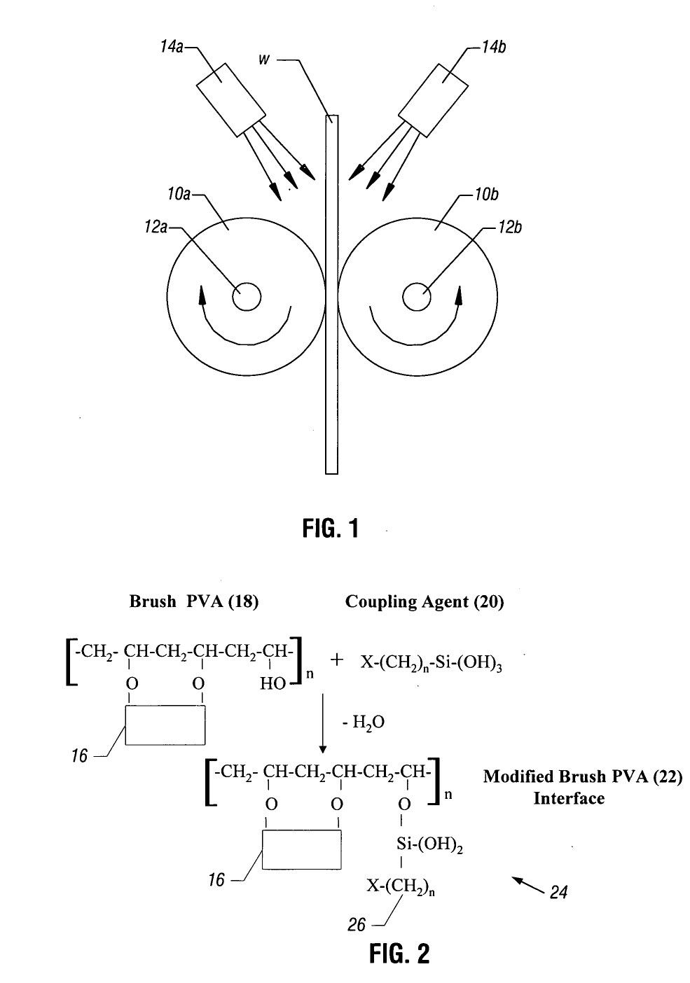

Referring to FIG. 1, a semiconductor wafer W may be cleaned by counter-rotating brushes 10a and 10b. Conventionally, the brushes 10 have a central axle 12a or 12b. Polymer bristles are attached to the central axle 12 to provide a scrubbing cleaning of the intervening wafer when the brushes 10 are counter-rotated. At the same time, chemical cleaning solution may be supplied from dispensers 14a and 14b at the brush/wafer interface. Cleaning solutions may also flow through the brushes 10 from their interiors.

Conventionally the brushes 10 may be made of polyvinyl alcohol. Most commonly, the brushes are formed of formal polyvinyl alcohol which has a methyl group which bridges between two spaced carbon groups along the polyvinyl alcohol chain.

Referring to FIG. 2, the polyvinyl alcohol chain 18 may have a repeating chain structure of the type indicated, including a plurality of carbon groups coupled one to the other to form a polymer. A moiety or moieties 16 may be coupled between two carbon atoms spaced by an intervening carbon atom. The moiety or moieties 16 may be coupled to the chain through oxygen molecules as illustrated. In formal polyvinyl alcohol, the moiety 16 is a methyl group. In conventional or non-formal polyvinyl alcohol, each oxygen atom is coupled to two separate hydrogen atoms that form the structure shown in the box 16. In such a structure, each unit of polyvinyl alcohol may include three hydroxyl groups, a hydroxyl group being coupled to every other carbon along the chain 18.

In order to improve the cleaning efficacy of the brushes 10, using conventional or formal polyvinyl alcohol, to mention two examples, a coupling agent 20 may be utilized. In one embodiment, the coupling agent 20 may be silane. The coupling agent 20 couples to one or more of the hydroxyl groups along the length of the polyvinyl alcohol chain 18. It may do so using a hydrolysis reaction giving up H₂O as indicated. However, the coupling agent 20 may be any entity which is capable of enabling the attachment of a ligand 24 to the length of the polyvinyl alcohol chain 18. The ligand 24 then generally extends away from the length of the modified interface 22 and provides its own separate cleaning element. This element acts as, in effect, a separate bristle extending from the length of the polyvinyl alcohol chain 18.

The number of such ligands 24 that may be attached is subject to considerable variability. In addition, the ligand 24, shown in FIG. 2, may have a subchain 26, indicated as (CH₂)ₙ. The length of the subchain 26 may be subject to considerable variability. For example, subchains 26 as short as two methyl groups may be possible and subchains as long as 40 methyl groups or longer may be feasible. The longer the subchain 26 of the methyl groups, the longer the extension of the attaching ligand 24 from the main chain 18. The longer its extension, the greater its effectiveness of the subchain 26 in acting as a relatively thin fiber to get into nooks and crannies on the wafer to be cleaned and to effectively clean small spaces.

Also attached to the ligand 24 is a moiety indicated as X. In one embodiment, the moiety X may include a functional species that may render the attaching ligand 24 hydrophobic, for example, if X is a hydrocarbon, such as methyl group. Conversely, if the moiety X is an ammonia group compound, it may render the ligand 24 hydrophilic. The moiety X may also be a functional species that enables the ligand 24 to act as an oxidizer, such as phosphate, or a reducing agent, such as nitrate. Alternatively, the X moiety may attract the ligand 24 to specific things that need to be cleaned on the semiconductor wafer. For example, if it is a copper surface that needs particular attention, a moiety X, such as benzotriazole that is attracted to copper may be utilized.

Thus, in accordance with some embodiments of the present invention, a chemical ligand 24 may be attached to a polymer chain 18 to provide specific cleaning functions, as well as enhanced mechanical functions due to the use of an effective microfiber that extends away from the interface 22. The ligand 24 may be formed by reacting a coupling agent 20 to the alcohol groups on the brush chain 18 in one embodiment. The ligand 24 may dangle from the brush interface and disrupt and/or reduce the boundary layer at the water surface, resulting in increased cleaning efficiency.

The ligand 24 can also serve to change the surface charge (zeta potential) of the brush 10. Thus, the user can engineer specific positive or negative zeta potentials of the brushes 10 by adding moieties X of specific charge, such as carboxylic acids, amines, or nitrates.

In some embodiments, a variety of characteristics of the ligand 24 may be altered. The length of the ligand may be altered in one embodiment. The nature of the moiety X may be altered. The surface charge may be altered in another embodiment. The extent of brush surface conversion to the ligands may be altered in some embodiments.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
attaching ligands along the length of a polymer to form a brush for cleaning semiconductor wafers.

2. The method of claim 1 including attaching ligands using a hydrolysis reaction.

3. The method of claim 1 including attaching ligands along the length of a polyvinyl alcohol polymer.

4. The method of claim 1 including using a coupling agent to attach ligands along the length of a polymer chain.

5. The method of claim 1 including attaching ligands to provide a hydrophilic property.

6. The method of claim 1 including attaching ligands to provide hydrophobic property.

7. The method of claim 1 including attaching ligands to provide a reducing agent property.

8. The method of claim 1 including attaching ligands to provide an oxidizing property.

9. The method of claim 1 including attaching ligands to provide an attraction to a specific material.

10. The method of claim 1 including attaching ligands to change the zeta potential.

11. The method of claim 1 including attaching a ligand having a subchain to the polymer.

12. The method of claim 11 including attaching a moiety to said subchain to provide a desired property to said ligand.

13. A method comprising:
cleaning a semiconductor wafer using a polymer brush having ligands attached along the length of a polymer.

14. The method of claim 13 including using a brush having ligands attached to polyvinyl alcohol polymer bristles.

15. The method of claim 13 including using a brush having ligands that to provide a hydrophilic property.

16. The method of claim 13 including using a brush having ligands that provide a hydrophobic property.

17. The method of claim 13 including using a brush having ligands that provide a reducing agent property.

18. The method of claim 13 including using a brush having ligands that provide an oxidizing property.

19. The method of claim 13 including using a brush having ligands that are attracted to a specific material.

20. The method of claim 13 including using a brush having ligands having a positive zeta potential.

21. The method of claim 13 including using a brush having ligands having a negative zeta potential.

22. The method of claim 13 including using a brush having a ligand having a subchain of at least two carbon atoms.

23. The method of claim 22 including using a brush having a moiety on said subchain to provide a desired property to said ligand.

24. A brush for cleaning semiconductor wafers comprising:
a polymer chain having ligands attached along the length of the chain.

25. The brush of claim 24 wherein said chain is a polyvinyl alcohol polymer chain.

26. The brush of claim 25 wherein said chain is a formal polyvinyl alcohol chain.

27. The brush of claim 24 wherein one of said ligands includes a hydrophilic moiety.

28. The brush of claim 24 wherein one of said ligands includes a hydrophobic moiety.

29. The brush of claim 24 wherein one of said ligands includes a reducing agent moiety.

30. The brush of claim 24 wherein one of said ligands includes an oxidizer.

31. The brush of claim 24 wherein one of said ligands includes a moiety attracted to a specific material.

32. The brush of claim 24 wherein one of said ligands includes a negative zeta potential moiety.

33. The brush of claim 24 wherein one of said ligands includes a positive zeta potential moiety.

34. The brush of claim 24 wherein one of said ligands is attached to a carbon chain having at least two carbon atoms.
